(19) United States
(12) Patent Application Publication
(10) Pub. No.: US 2007/0001322 A1
(43) Pub. Date: Jan. 4, 2007

(54) METHOD AND APPARATUS FOR TREATING LNG

(76) Inventors: Christy Efeilomo Aikhorin, Lagos (NG); Gerrit Konijn, Amsterdam (NL); Eveline Iris Otten, The Hague (NL); Marc Alexander Rieder, The Hague (NL)

Correspondence Address: SHELL OIL COMPANY, P O BOX 2463, HOUSTON, TX, 772522463, US

(21) Appl. No.: 11/420,319

(22) Filed: May 25, 2006

(30) Foreign Application Priority Data
Jun. 1, 2005 (WO) PCT/EP05/06636
Jul. 13, 2005 (WO) PCT/EP05/53363

(51) Int. Cl. B01F 3/04; F25J 3/00

(52) U.S. Cl. 261/75; 62/625

(57) ABSTRACT

The present invention relates to a method of treating a liquefied natural gas (LNG) stream, the method at least comprising the steps of: (a) supplying a stream comprising LNG as at least two separate streams to a vessel comprising a contacting zone, a first stream being fed above the contacting zone and a second stream being fed below the contacting zone; (b) supplying a stream comprising an inert fluid to the vessel; (c) contacting at least the first stream supplied in step (a) with the stream supplied in step (b) in the contacting zone, thereby obtaining an LNG stream being enriched in inert fluid; and (d) removing the LNG stream obtained in step (c) from the vessel.

### CROSS-REFERENCE TO RELATED APPLICATIONS

This application claims the benefit of Patent Application No. PCT/EP2005/006636, filed Jun. 1, 2005, and Patent Application No. PCT/EP2005/053363, filed Jul. 13, 2005, which are incorporated herein by reference.

### FIELD OF THE INVENTION

The present invention relates to a method of treating a liquefied natural gas (LNG) stream.

### BACKGROUND OF THE INVENTION

It is desirable to liquefy a natural gas stream for a number of reasons. As an example, natural gas can be stored and transported over long distances more readily as a liquid than in gaseous form, because it occupies a smaller volume and does not need to be stored at high pressures.

It is known to treat an LNG stream in order to obtain natural gas having a desired gas quality, e.g. a selected heating value (i.e. energy content when the gas is burned), according to gas specifications or the requirements of a consumer. To this end the liquefied natural gas stream is usually pressurized and vaporised (thereby obtaining regasified LNG), and subsequently a selected amount of pressurized nitrogen is added to obtain a desired heating value.

The nitrogen is usually injected into the regasified LNG. To this end the nitrogen needs to be compressed to similar or higher pressure than the regasified LNG.

Examples of the addition of nitrogen to lower the heating value of natural gas have been disclosed in U.S. Pat. No. 3,658,499 and GB 1,280,342.

A problem of the known methods of treating an LNG stream as described above is that it is highly energy consuming.

It is an object of the present invention to minimize the above problem.

It is a further object to provide an alternative method of treating an LNG stream thereby obtaining a natural gas stream having a selected energy content.

One or more of the above or other objects are achieved according to the present invention by providing a method of treating a liquefied natural gas (LNG) stream, the method at least comprising the steps of:

(a) supplying a stream comprising LNG as at least two separate streams to a vessel comprising a contacting zone, a first stream being fed above the contacting zone and a second stream being fed below the contacting zone;

(b) supplying a stream comprising an inert fluid to the vessel;

(c) contacting at least the first stream supplied in step (a) with the stream supplied in step (b) in the contacting zone, thereby obtaining an LNG stream being enriched in inert fluid; and

(d) removing the LNG stream obtained in step (c) from the vessel.

It has surprisingly been found that using the method according to the present invention, a significant energy reduction may be obtained, as the N₂ or other suitable inert fluid injected to eventually obtain the desired energy content for the natural gas does not need to be pressurized to a high pressure. Also, a significant cost reduction may be obtained as the equipment for pressurizing the N₂ or other inert fluid may be dispensed with.

A further advantage of the present invention is that the occurrence of cavitation in downstream pumps is prevented or at least minimized.

The liquefied natural gas stream supplied in step (a) may be any LNG stream, and will usually be obtained from an LNG storage tank. Usually the LNG comprises compounds selected from the group consisting of methane, ethane, propane, butanes and pentanes, or a combination thereof. Also other hydrocarbons may be present. Usually the LNG stream is low in aromatic hydrocarbons and non-hydrocarbons such as H₂O, N₂, CO₂, H₂S and other sulphur compounds, and the like, as these compounds have usually been removed at least partially before liquefying the natural gas stream, which is then stored or transported in liquid form.

The inert fluid may be any suitable vaporous or liquid fluid for selectively adjusting the energy content of the LNG. As an example air or substantially pure N₂ may be used. As the person skilled in the art will readily understand how the energy content can be adjusted using the inert fluid, this is not further discussed here.

The inert fluid may be supplied to the vessel separately from the LNG stream (preferably at the top of the vessel), but both streams may also first be combined and subsequently be supplied as a single stream to the vessel (again, preferably at the top of the vessel).

The vessel in which the inert fluid and LNG are contacted may be any suitable vessel, as long as it contains a contacting zone, i.e. a section in which the inert fluid and LNG are contacted. Preferably, the contacting zone comprises a packing to further enhance the contact. As a result of the contacting in step (c), an LNG stream being enriched in inert fluid is obtained which is removed from the vessel in step (d). As the LNG stream removed in step (d) is enriched in inert fluid, it has a lower energy content and therefore is a “leaner LNG stream” .

Preferably, in step (a) the stream comprising LNG is supplied to the vessel at a pressure of from 4 to 13 bar, preferably from 6 to 11 bar, more preferably from 7 to 10 bar.

According to a preferred embodiment the stream supplied in step (b) comprises at least 75 vol % N₂, preferably at least 80 vol % N₂, more preferably at least 90 vol % N₂.

Further it is preferred that the amount of N₂ supplied in step (b) is selected such that the LNG stream removed in step (d) comprises at most 5 vol % N₂.

Also it is preferred that the method further comprises the steps of:

(e) optionally pressurizing the LNG stream obtained in step (d), preferably to a pressure in the range from 8 to 110 bar, thereby obtaining a pressurized LNG stream; and

(f) vaporizing the stream obtained in step (d) or (e), thereby obtaining natural gas (or ‘regasified LNG’) comprising a selected amount of inert fluid.

According to a particularly preferred embodiment also a boil off vapour stream is supplied to the vessel, the boil off vapour stream originating from a source of LNG. Preferably, the boil off vapour stream is supplied to the vessel at a pressure of from 4 to 13 bar, preferably from 6 to 11 bar, more preferably from 7 to 10 bar.

The inert fluid may be supplied to the vessel separately from the boil off vapour stream, but both streams may also first be combined and subsequently be supplied as a single stream to the vessel.

Preferably, the inert fluid is combined with the boil off vapour stream having a pressure of 4 to 13 bar before being supplied to the vessel. In the latter case, the inert fluid stream preferably also has a pressure of from 4 to 13 bar.

An important advantage of adding the inert fluid to the boil off vapour stream is that hereby the formation of bubbles (‘cavitation’) in the LNG stream removed in step (d) is substantially prevented. These bubbles might occur if the inert fluid would e.g. be added to the second stream being fed below the contacting zone, as is suggested e.g. in earlier filed but non-prepublished application WO 2005/061951 Al. The presence of bubbles in the LNG stream removed in step (d) may be harmful for downstream pumps.

It is especially preferred that the LNG stream supplied in step (a) is a subcooled LNG stream. Herewith, a part of the cold in the subcooled LNG stream is used to recondense the boil off vapour stream and the inert fluid.

In a further aspect the present invention relates to an apparatus for treating a liquefied natural gas (LNG) stream, the apparatus at least comprising a vessel, the vessel comprising:
a contacting zone for contacting a stream comprising LNG and a stream comprising an inert fluid, thereby obtaining an LNG stream being enriched in inert fluid;
a first and a second inlet for supplying the stream to the vessel as at least two separate streams, the first inlet being above the contacting zone and the second inlet being below the contacting zone;
a third inlet for supplying the stream comprising the inert fluid to the vessel; and
an outlet for removing an LNG stream being enriched in inert fluid from the vessel.

Hereinafter the invention will be further illustrated by the following non-limiting drawing. Herein shows:

### BRIEF DESCRIPTION OF THE DRAWINGS

FIG. 1 schematically a process scheme not in accordance with the present invention, but incorporated for illustration purposes; and

FIG. 2 schematically a process scheme in accordance with the present invention.

For the purpose of this description, a single reference number will be assigned to a line as well as a stream carried in that line. Same reference numbers refer to similar components.

### DETAILED DESCRIPTION OF THE DRAWINGS

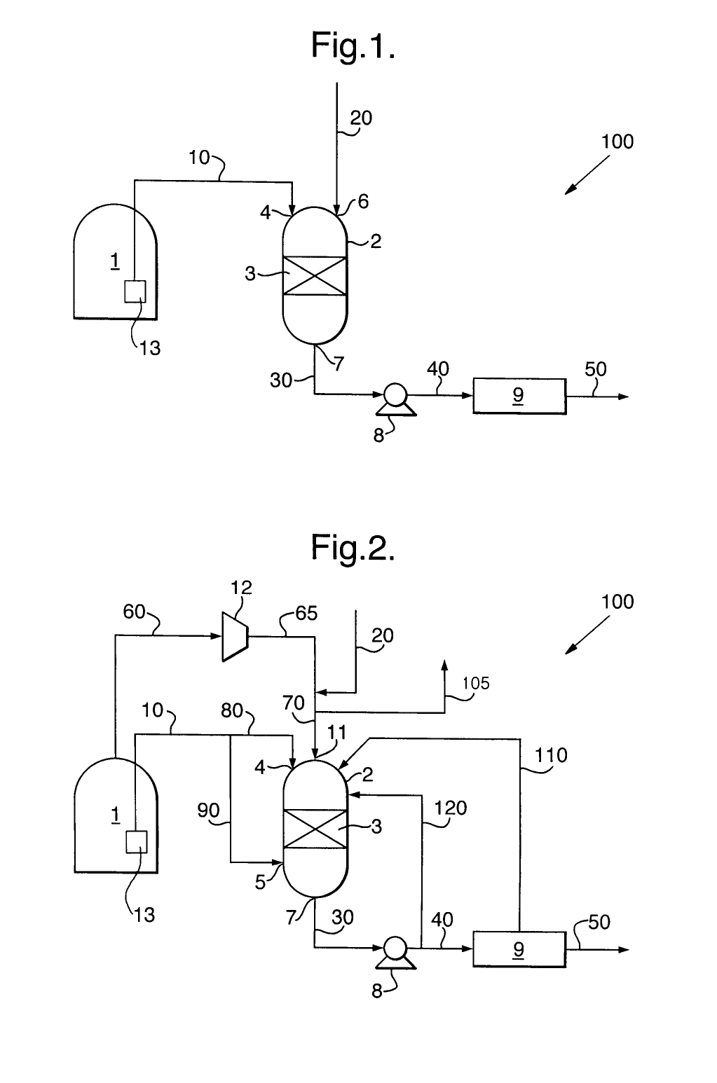

FIG. 1 schematically shows a process scheme (and apparatus generally indicated with reference number 100) not in accordance with the present invention (as it does not show all the features of the main claims), but incorporated for illustration purposes only.

A stream 10 containing liquefied natural gas (LNG) is pumped (using e.g. an in-tank pump 13) from an LNG source such as a storage tank 1 to the first inlet 4 of a vessel 2 having a contacting zone 3 such as a packing.

Usually the stream 10 is a subcooled LNG stream and has a pressure of between 4 to 13 bar, preferably about 8 bar, while the pressure of the LNG in the storage tank 1 is about atmospheric.

Further a stream 20 being substantially comprised of N₂ is supplied to the vessel 2 at an inlet 6 of the vessel 2.

After contacting the streams 10 and 20 in the contacting zone 3 of the vessel 2, a stream 30 is removed at outlet 7 from the vessel 2. The stream 30 preferably contains at most 5 vol % N₂.

In the embodiment of FIG. 1, the stream 30 is further processed by pressurizing in a high-pressure pump 8 thereby obtaining a stream 40 having a pressure in the range of about 8 to 110 bar. Then, the stream 40 is vaporised in a vaporiser 9 thereby obtaining a gaseous natural gas stream 50 having a selected energy content, which may be sent to the grid (not shown). The amount of N₂ supplied to the vessel 2 will depend on the desired energy content for the natural gas to be obtained in stream 50.

FIG. 2 shows an exemplary process scheme of an embodiment of the method according to the present invention, which process scheme can be used in an LNG import terminal. The elements already discussed in FIG. 1 will not be discussed here again.

In the embodiment of FIG. 2 the stream 10 is supplied as two separate streams to the vessel 2, i.e. first stream 80 and second stream 90; the first stream 80 is fed above the contacting zone 3 at first inlet 4 and the second stream 90 is fed below the contacting zone 3 at second inlet 5. If desired, stream 10 may be supplied to the vessel 2 as more than two separate streams.

According to the embodiment of FIG. 2 also a boil off vapour stream 60 coming from the LNG storage tank 1 is fed to the vessel 2 at third inlet 11. The third inlet 11 is preferably at the top of the vessel 2, above the contacting zone 3.

Before feeding the stream 60 to the vessel 2, it is pressurized by compressing the stream 60 (usually being at atmospheric pressure) in compressor 12 thereby obtaining compressed boil off vapour stream 65. By combining stream 20 and stream 65, combined stream 70 is obtained. The stream 70 usually has a pressure in the range of 4 to 13 bar, preferably about 8 bar. If desired streams 65 and 20 may be added as separate streams (and as a result at separate inlets) to the vessel 2, preferably at the top of the vessel 2. However, it is preferred to combine streams 65 and 20 before supplying it as combined stream 70 to the vessel 2 at third inlet 11 (being preferably at the top of the vessel 2).

The person skilled in the art will readily understand that other streams may be present in the process scheme, e.g. to control the pressure and the liquid level in the vessel 2. As an example, the pressure within the vessel 2 is controlled by low-pressure stream 105 and high-pressure stream 110. Further, stream 120 is fed as a kickback stream from the high-pressure pump 8 to the vessel 2.

Table I gives an overview of the composition and conditions of a stream at various parts in an example process of FIG. 2. As can be seen from Table I, the energy content (i.e. heating value) of stream 10 has been selectively adjusted (i.e. decreased) from 1170 to a value of 1116 Btu/scf in stream 30. The temperature and pressure of the streams 80 and 90 differ slightly, as the pipe for stream 90 is longer. As a result stream 90 experiences more cold leak and more pressure drop than stream 80.

TABLE I

| | 10 | 65 | 20 | 70 | 80 | 90 | 30 |
|---|---|---|---|---|---|---|---|
| Phase | liquid | vapour | vapour | vapour | liquid | liquid | liquid |
| Total rate (kgmol/h) | 20433 | 894 | 889 | 1786 | 20352 | 81 | 22217 |
| Temperature (° C.) | −157.1 | −48 | 45 | −6.3 | −157.1 | −146.9 | −142.6 |
| Pressure (bara) | 8.0 | 8.0 | 8.0 | 8.0 | 8.0 | 7.5 | 7.5 |
| HHV* (Btu/scf)** | 1170 | 1010 | 0 | 506 | 1170 | 1170 | 1116 |
| Molar percentage | | | | | | | |
| N₂ | — | — | 100 | 49.87 | — | — | 4 |
| Methane | 87.51 | 99.99 | — | 50.12 | 87.51 | 87.51 | 84.51 |
| Ethane | 6.19 | 0.01 | — | 0.01 | 6.19 | 6.19 | 5.7 |
| Propane | 4.5 | — | — | — | 4.5 | 4.5 | 4.14 |
| iso-butane | 0.6 | — | — | — | 0.6 | 0.6 | 0.55 |
| n-butane | 0.6 | — | — | — | 0.6 | 0.6 | 0.55 |
| iso-pentane | 0.6 | — | — | — | 0.6 | 0.6 | 0.55 |
| n-pentane | — | — | — | — | — | — | — |

*HHV = Heating Value
**Btu/scf = British thermal units per square cubic feet

What is claimed is:

1. Method of treating a liquefied natural gas (LNG) stream, the method at least comprising the steps of:
(a) supplying a stream comprising LNG as at least two separate streams to a vessel comprising a contacting zone, a first stream being fed above the contacting zone and a second stream being fed below the contacting zone;
(b) supplying a stream comprising an inert fluid to the vessel, preferably at the top of the vessel;
(c) contacting at least the first stream supplied in step (a) with the stream supplied in step (b) in the contacting zone, thereby obtaining an LNG stream being enriched in inert fluid; and
(d) removing the LNG stream obtained in step (c) from the vessel.

2. Method according to claim 1, wherein in step (a) the stream comprising LNG is supplied to the vessel at a pressure of from 4 to 13 bar.

3. Method according to claim 1, wherein the stream supplied in step (b) comprises at least 75 vol % N₂.

4. Method according to claim 3, wherein the amount of N₂ supplied in step (b) is selected such that the LNG stream removed in step (d) comprises at most 5 vol % N₂.

5. Method according to claim 1, wherein the method further comprises the steps of:
(e) optionally pressurizing the LNG stream obtained in step (d) thereby obtaining a pressurized LNG stream; and
(f) vaporizing the stream obtained in step (d) or (e), thereby obtaining natural gas comprising a selected amount of inert fluid.

6. Method according to claim 1, wherein also a boil off vapour stream is supplied to the vessel, the boil off vapour stream originating from a source of LNG.

7. Method according to claim 6, wherein the boil off vapour stream is supplied to the vessel at a pressure of from 4 to 13 bar.

8. Method according to claim 6, wherein the boil off vapour stream is compressed in a compressor before being supplied to the vessel.

9. Method according to claim 6, wherein the boil off vapour stream and the stream comprising an inert fluid are combined before being supplied to the vessel.

10. Method according to claim 1, wherein the stream supplied in step (a) is a subcooled LNG stream.

11. Apparatus for treating a liquefied natural gas (LNG) stream, the apparatus at least comprising a vessel comprising:
a contacting zone for contacting a stream comprising LNG and a stream comprising an inert fluid, thereby obtaining an LNG stream being enriched in inert fluid;
a first and a second inlet for supplying the stream to the vessel as at least two separate streams, the first inlet being above the contacting zone and the second inlet being below the contacting zone;
a third inlet for supplying the stream comprising the inert fluid to the vessel, the third inlet being preferably at the top of the vessel; and
an outlet for removing an LNG stream being enriched in inert fluid from the vessel.

12. Apparatus according to claim 11, further comprising an inlet for supplying a boil off vapour stream to the vessel, the boil off vapour stream originating from a source of LNG.

13. Apparatus according to claim 12, further comprising a compressor for compressing the boil off vapour stream, thereby obtaining a compressed boil off vapour stream.

14. Apparatus according to claim 12, being adapted for combining the boil off vapour stream and the inert fluid between the compressor and the vessel.

15. Method according to claim 2, wherein the stream supplied in step (b) comprises at least 75 vol % N₂.

16. Method according to claim 2, wherein the method further comprises the steps of:
(e) optionally pressurizing the LNG stream obtained in step (d) thereby obtaining a pressurized LNG stream; and
(f) vaporizing the stream obtained in step (d) or (e), thereby obtaining natural gas comprising a selected amount of inert fluid.

17. Method according to claim 3, wherein the method further comprises the steps of:
(e) optionally pressurizing the LNG stream obtained in step (d) thereby obtaining a pressurized LNG stream; and
(f) vaporizing the stream obtained in step (d) or (e), thereby obtaining natural gas comprising a selected amount of inert fluid.

18. Method according to claim 4, wherein the method further comprises the steps of:
(e) optionally pressurizing the LNG stream obtained in step (d) thereby obtaining a pressurized LNG stream; and
(f) vaporizing the stream obtained in step (d) or (e), thereby obtaining natural gas comprising a selected amount of inert fluid.

19. Method according to claim 9, wherein the boil off vapour stream and the stream comprising an inert fluid are combined between the compressor and the third inlet of the vessel.

20. Method according to claim 7, wherein the boil off vapour stream and the stream comprising an inert fluid are combined before being supplied to the vessel.
